(19) United States
(12) Patent Application Publication
(10) Pub. No.: US 2008/0255896 A1
(43) Pub. Date: Oct. 16, 2008

(54) SYSTEM AND METHOD FOR AIDING A BUYER TO CREATE A SUPPLIER SCORECARD

(75) Inventors: CHI-CHIH WANG, Tu-Cheng (TW); BING-YU HE, Shenzhen (CN); BO LIU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/960,722

(22) Filed: Dec. 20, 2007

(30) Foreign Application Priority Data
Apr. 12, 2007 (CN) 200710200430.8

(51) Int. Cl. G06Q 10/00

(52) U.S. Cl. 705/7

(57) ABSTRACT

A method for aiding a buyer to create a scorecard of a supplier is disclosed. The method comprising the steps of allowing the buyer to select a scoring category for the supplier; allowing the buyer to select a criterion of the scoring category for the supplier; instructing the buyer to input the supplier's performed data related to the selected criterion; calculating a point of the supplier under the selected criterion; obtaining a rating of the supplier under the selected criterion; storing in the database the calculated point and the obtained rating; determining whether the supplier has been rated for all scoring categories if the supplier has been rated for all the criteria of the scoring category; and creating the scorecard of the supplier based on points and ratings of all the criteria of all the scoring categories. A related system is also disclosed.

### BACKGROUND OF THE INVENTION

1. Field of the Invention

The present invention relates to a system and method for aiding a buyer to create a supplier scorecard.

2. Description of Related Art

Selecting the best supplier for a company or enterprise is of enormous importance and has a significant impact on the company's success in the marketplace. Despite this importance, it is often difficult to collect and present the characteristics of a group of potential suppliers in a way that facilitates objective evaluation in the course of a request for proposal evaluation or similar activity. Sometimes data that attempts to do this is distributed around separate systems and lacks currency. In other cases the supplier selection process relies too heavily on the subjective judgment of management or other personnel. Comprehensive databases of request for proposal information can be created to assist, but it is often difficult to view the data in a meaningful way. Ideally, supplier evaluation processes that ultimately lead to supplier selection should be monitored and made as objective as possible, while still making use valuable personal insight and experience where appropriate.

What is needed, therefore, is a system that can aid a buyer to create a scorecard of a supplier to evaluate the supplier performance.

What is also needed, therefore, is a method that can aid a buyer to create a scorecard of a supplier to evaluate the supplier performance.

### SUMMARY OF THE INVENTION

A system for aiding a buyer to create a scorecard of a supplier is disclosed. The system includes a database and an application server electronically connected with the database, the database including one or more scoring categories for the supplier, each of the scoring categories including one or more criteria, the database further including different calculation formula for calculating supplier's points related to different criteria and different rating standards for evaluating the supplier's ratings under the different criteria. The application server includes a selecting module allowing the buyer to select a scoring category for the supplier, displaying all criteria of the scoring category after the buyer has selected the scoring category, and allowing the buyer to select a criterion of the scoring category for the supplier; an inputting module instructing the buyer to input the supplier's performed data related to the selected criterion; a calculating module for calculating a point of the supplier under the selected criterion according to the inputted supplier's performed data and a corresponding calculation formula for the selected criterion, and obtaining a rating of the supplier under the selected criterion according to the calculated point of the supplier under the selected criterion and a corresponding scoring standard of the selected criterion; a storing module for storing in the database the calculated point of the supplier under the selected criterion and the obtained rating of the supplier under the selected criterion; a determining module for determining whether the supplier has been rated for all the criteria of the scoring category, and determining whether the supplier has been rated for all scoring categories; and a creating module for creating the scorecard of the supplier based on points and ratings of all the criteria of all the scoring categories.

Another preferred embodiment provides a method for aiding a buyer to create a scorecard of a supplier is disclosed. The method includes the steps of allowing the buyer to select a scoring category for the supplier, displaying all criteria of the scoring category after the buyer has selected the scoring category; allowing the buyer to select a criterion of the scoring category for the supplier; instructing the buyer to input the supplier's performed data related to the selected criterion; calculating a point of the supplier under the selected criterion according to the inputted supplier's performed data and a corresponding calculation formula for the selected criterion stored in the database; obtaining a rating of the supplier under the selected criterion according to the calculated point of the supplier under the selected criterion and a corresponding scoring standard of the selected criterion stored in the database; storing in the database the calculated point of the supplier under the selected criterion and the obtained rating of the supplier under the selected criterion; determining whether the supplier has been rated for all the criteria of the scoring category; determining whether the supplier has been rated for all scoring categories if the supplier has been rated for all the criteria of the scoring category; and creating the scorecard of the supplier based on points and ratings of all the criteria of all the scoring categories if the supplier has been rated for all the criteria of the scoring category.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for aiding a buyer to create a supplier scorecard in accordance with a preferred embodiment;

FIG. 2 is a schematic diagram of main software function modules of an application server of FIG. 1; and

FIG. 3 is a flowchart of a method for aiding a buyer to create a supplier scorecard in accordance with a preferred embodiment.

### DETAILED DESCRIPTION OF THE INVENTION

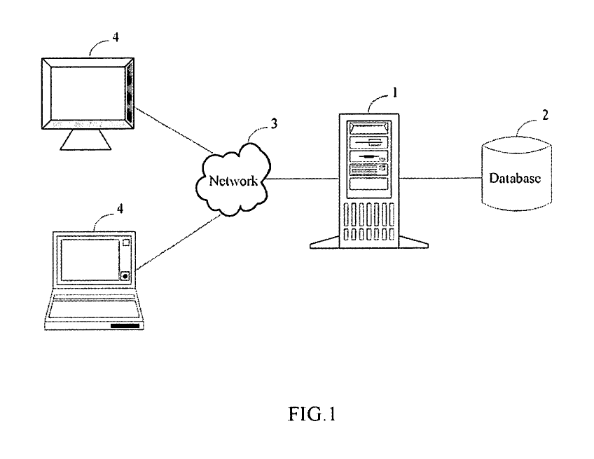

FIG. 1 is a schematic diagram of a hardware configuration of a system for aiding a buyer to create a supplier scorecard (hereinafter, “the system”) in accordance with a preferred embodiment. The system typically includes an application server 1, a database 2, and a plurality of clients 4 (only two shown). The application server 1 communicates with the clients 4 via a network 3. The network 3 may be an intranet, the Internet, or any other type of communications link. Each of the plurality of clients 4 is configured (i.e., structured and arranged) for providing an interactive interface that enables buyers to perform relevant operations so as to create a supplier scorecard.

The application server 1 further connects to the database 2. The database 2 is configured for storing different kinds of data used in the system, such as calculation formula and scoring standards for creating the scorecard.

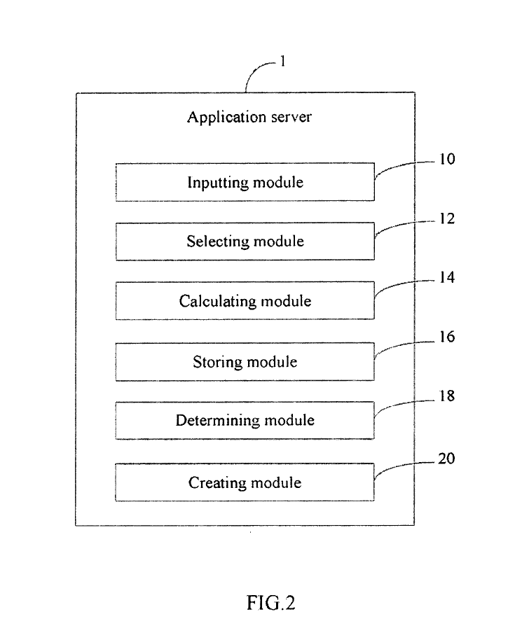

FIG. 2 is a schematic diagram of main software function modules of the application server 1. The application server 1 may include an inputting module 10, a selecting module 12, a calculating module 14, a storing module 16, a determining module 18, and a creating module 20.

The inputting module 10 is configured for the buyer to input relevant data used in the system, such as a current time and basic information of a supplier. The information of the supplier includes, for example, a supplier name and materials provided by the supplier, etc.

The selecting module 12 is configured for allowing the buyer to select a scoring category for the supplier, displaying all criteria of the scoring category after the buyer has selected the scoring category. The scoring categories include, but not limited to, quality performance of the supplier and delivery performance of the supplier. Each scoring category may include one or more criteria. For example, the quality performance of a supplier may include early return index (ERI) of materials provided by the supplier, factory return quality (FRQ) of materials provided by the supplier, customer quality audit (CQA), and defect per million unit (DPMU) of materials provided by the supplier.

The selecting module 12 is also configured for allowing the buyer to select a criterion of the scoring category for scoring the criterion for the supplier.

The inputting module 10 is also configured for instructing the buyer to input the supplier's performed data related to the selected criterion.

The calculating module 14 is configured for calculating a point of the supplier under the selected criterion according to the inputted supplier's performed data and a corresponding calculation formula for the selected criterion stored in the database 2.

The calculating module 14 is also configured for obtaining a rating of the supplier under the selected criterion according to the calculated point of the supplier under the selected criterion and a corresponding scoring standard of the selected criterion stored in the database 2.

The storing module 16 is configured for storing in the database 2 the calculated point of the supplier under the selected criterion and the obtained rating of the supplier under the selected criterion.

The determining module 18 is configured for determining whether the supplier has been rated for all the criteria of the scoring category. The determining module 18 is also configured for determining whether the supplier has been rated for all scoring categories if all the criteria of the scoring category have been rated.

The creating module 20 is configured for creating the scorecard of the supplier based on points and ratings of all criteria of all the scoring if all the scoring categories for the supplier have been rated.

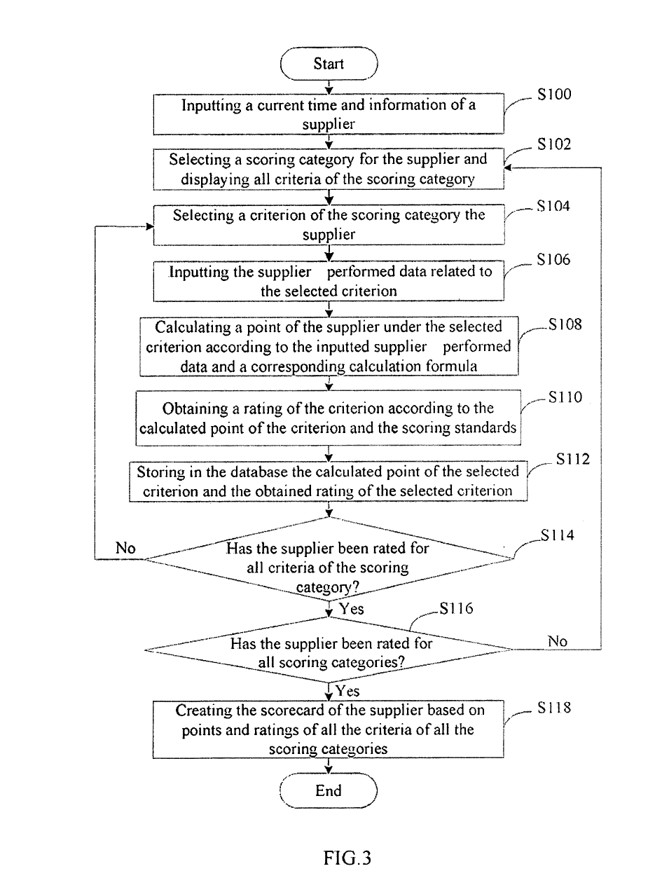

FIG. 3 is a flowchart of a method for aiding a buyer to create a supplier scorecard in accordance with a preferred embodiment. In step S100, the buyer inputs through the inputting module 10 relevant data used in the system, such as the current time and basic information of a supplier.

In step S102, the buyer selects through the selecting module 12 the scoring category for the supplier, and all criteria of the scoring category are displayed after the buyer has selected the scoring category.

In step S104, the buyer selects a criterion of the scoring category for the supplier through the selecting module 12.

In step S106, the buyer inputs supplier's performed data related to the selected criterion through the inputting module 10.

In step S108, the calculating module 14 calculates a point of the supplier under the selected criterion according to the inputted supplier's performed data and a corresponding calculation formula for the selected criterion stored in the database 2.

In step S110, the calculating module 14 obtains a rating of the supplier under the selected criterion according to the calculated point of the supplier under the selected criterion and a corresponding scoring standard stored of the selected criterion in the database 2.

In step S112, the storing module 16 stores in the database 2 the calculated point of the supplier under the selected criterion and the obtained rating of the supplier under the selected criterion.

In step S114, the determining module 18 determines whether the supplier has been rated for all the criteria of the scoring category. If there is any criteria of the scoring category has not been rated, the procedure returns to step S104 described above. Otherwise, if the supplier has been rated for all the criteria of the scoring category, in step S116, the determining module 18 determines whether the supplier has been rated for all scoring categories.

If there is any scoring category for the supplier has not been rated, the procedure returns to step S102 described above. Otherwise, if the supplier has been rated for all the scoring categories, in step S118, the creating module 20 creates the scorecard of the supplier based on points and ratings of all criteria of all the scoring categories.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for aiding a buyer to create a scorecard of a supplier comprising a database and an application server electronically connected with the database, the database including one or more scoring categories for the supplier, each of the scoring categories including one or more criteria, the database further including different calculation formula for calculating supplier's points related to different criteria and different rating standards for evaluating the supplier's ratings under the different criteria, the application server comprising:
a selecting module allowing the buyer to select a scoring category for the supplier, displaying all criteria of the scoring category after the buyer has selected the scoring category, and allowing the buyer to select a criterion of the scoring category for the supplier;
an inputting module instructing the buyer to input the supplier's performed data related to the selected criterion;
a calculating module for calculating a point of the supplier under the selected criterion according to the inputted supplier's performed data and a corresponding calculation formula for the selected criterion, and obtaining a rating of the supplier under the selected criterion according to the calculated point of the supplier under the selected criterion and a corresponding scoring standard of the selected criterion;
a storing module for storing in the database the calculated point of the supplier under the selected criterion and the obtained rating of the supplier under the selected criterion;
a determining module for determining whether the supplier has been rated for all the criteria of the scoring category, and determining whether the supplier has been rated for all scoring categories; and
a creating module for creating the scorecard of the supplier based on points and ratings of all the criteria of all the scoring categories.

2. The system as claimed in claim 1, wherein the scoring categories include quality performance of the supplier.

3. The system as claimed in claim 1, wherein the scoring categories include delivery performance of the supplier.

4. A method for aiding a buyer to create a scorecard of a supplier, the method comprising:
allowing the buyer to select a scoring category for the supplier, displaying all criteria of the scoring category after the buyer has selected the scoring category;
allowing the buyer to select a criterion of the scoring category for the supplier;
instructing the buyer to input the supplier's performed data related to the selected criterion;
calculating a point of the supplier under the selected criterion according to the inputted supplier's performed data and a corresponding calculation formula for the selected criterion stored in the database;
obtaining a rating of the supplier under the selected criterion according to the calculated point of the supplier under the selected criterion and a corresponding scoring standard of the selected criterion stored in the database;
storing in the database the calculated point of the supplier under the selected criterion and the obtained rating of the supplier under the selected criterion;
determining whether the supplier has been rated for all the criteria of the scoring category;
determining whether the supplier has been rated for all scoring categories if the supplier has been rated for all the criteria of the scoring category; and
creating the scorecard of the supplier based on points and ratings of all the criteria of all the scoring categories if the supplier has been rated for all the criteria of the scoring category.

5. The method as claimed in claim 4, wherein the scoring categories include quality performance of the supplier.

6. The method as claimed in claim 4, wherein the scoring categories include delivery performance of the supplier.
